(19) United States
(12) Patent Application Publication
(10) Pub. No.: US 2019/0139087 A1
(43) Pub. Date: May 9, 2019

(54) Systems and Methods for Acquiring Consent from a Party Subject to Online Advertisement

(71) Applicants: David Dabbs, Evanston, IL (US); Daniel Shore, Chicago, IL (US); Mateen Moosa, Chicago, IL (US)

(72) Inventors: David Dabbs, Evanston, IL (US); Daniel Shore, Chicago, IL (US); Mateen Moosa, Chicago, IL (US)

(21) Appl. No.: 16/182,282

(22) Filed: Nov. 6, 2018

Related U.S. Application Data
(60) Provisional application No. 62/582,013, filed on Nov. 6, 2017.

(51) Int. Cl. G06Q 30/02; G06F 16/958; G06F 16/957; G06F 3/0482; G06F 3/0484

(52) U.S. Cl. CPC G06Q 30/0251; G06F 16/958; G06F 3/04842; G06F 3/0482; G06F 16/957

(57) ABSTRACT

A method for gaining consent to target advertising to and to collect data from a subject to online advertising includes providing, to the subject to online advertising at a computing device associated with the subject to online advertising, instructions for a consent dialogue window, the consent dialogue window served to the subject. The consent dialogue window is presented to the subject as an overlay to a website. The consent dialogue window includes a non-consent affirmation box, which, if affirmatively indicated, indicates to the consent server that the subject to online advertising does not consent to targeted advertising and collection of data, and a media declaration which accurately informs the subject that if any affirmative indication is made outside indicatable areas, which include, at least, the non-consent affirmation box, then the subject to online advertising consents to online advertisement and data collection from the vendor server and partner vendor servers.

### TECHNICAL FIELD

The present disclosure relates generally to digital media advertising and, more particularly, to systems for acquiring consent to be subject to targeted advertising.

### BACKGROUND

In the field of digital media advertising, particularly with regards to data-based, targeted advertising, the subject of the advertising (e.g., a consumer on a computing device, referenced hereinafter as the “subject”) may be provided with dialog prompts, both graphic and/or text based, that offer the subject an opportunity to “opt out” of being a subject to targeted advertising. Such opt out systems may be configured and/or regulated by certain consortiums or consumer groups associated with the targeted advertising.

To that end, certain regulations in various jurisdictions may make the granting of consent to an online advertiser mandatory. Accordingly, online advertisers may generate consent tools within or adjacent to their advertising interface to acquire consent from a subject. Therefore, it is desired, for online advertisers, to have consent acquisition systems and methods that provide minimal disturbance to the subjects within such jurisdictions that minimize advertiser integration friction.

### SUMMARY

In accordance with one aspect of the disclosure, a method for gaining consent to target advertising to and to collect data from a subject to online advertising is disclosed. The method includes providing, to the subject to online advertising at a computing device associated with the subject to online advertising, instructions for a consent dialogue window, the consent dialogue window served to the subject to online advertising, at the computing device, from a consent server, the consent server including, at least, a first processor, a first memory, and a first transceiver. The consent dialogue window is presented to the subject to online advertising as an overlay to a website served to the subject to online advertising, the website served to the subject to online advertising via a vendor server, the vendor server including, at least, a second processor, a second memory, and a second transceiver. The consent dialogue window includes, at least, a non-consent affirmation box, which, if affirmatively indicated, indicates to the consent server that the subject to online advertising does not consent to targeted advertising and collection of data from at least one of the vendor server and one or more partner vendor servers, the non-consent affirmation box defined by a specific pixel grouping within the consent dialogue window, and a media declaration which accurately informs the subject to online advertising that if any affirmative indication is made outside of one or more indicatable areas, which include, at least, a non-consent affirmation box, then the subject to online advertising consents to online advertisement and data collection from the vendor server and the one or more partner vendor servers. The method further includes requesting a consent status of the subject to online advertisement from at least one of the vendor server and the one or more partner vendor servers, by the consent server, receiving the consent status of the subject to online advertisement from the at least one of the vendor server and the one or more partner vendor servers, by the consent server, wherein the consent status indicates one or more of consent, non-consent, and unavailable consent information, for the subject to online advertisement, and if the consent status indicates non-consent or unavailable consent, instruct the computing device, at a web browser, to execute the instructions for the consent dialogue prompt.

In accordance with another aspect of the disclosure, if the consent status indicates non-consent or unavailable consent, instruct the computing device, at a web browser, to execute the instructions for the consent dialogue prompt is disclosed. The system includes at least one wireless transceiver, configured to connect, in electronic communication the system to a computing device associated with the subject and a vendor server, a non-transitory, machine readable medium having thereon consent instructions, and a processor configured to execute the consent instructions. The consent instructions, when executed by the processor, cause the processor to provide, to the subject via the computing device, instructions for a consent dialogue window, the consent dialogue window served to the subject to online advertising. The consent dialogue window is presented to the subject as an overlay on a website served to the subject to online advertising, the website being served to the subject via the vendor server. The consent dialogue window includes a non-consent affirmation box, which if affirmatively indicated, indicates to the consent server that the subject does not consent to targeted advertising and collection of data from at least one of the vendor server and one or more partner vendor servers, the non-consent affirmation box defined by a specific pixel grouping within the consent dialogue window. The consent dialogue window further includes a media declaration which accurately informs the subject that if any affirmative indication is made outside of one or more indicatable areas, which include, at least, a non-consent affirmation box, then the subject to online advertising consents to online advertisement and data collection from the vendor server and the one or more partner vendor servers. The consent instructions, when executed, further cause the processor to request a consent status of the subject from at least one of the vendor server and the one or more partner vendor servers, receive the consent status of the subject the at least one of the vendor server and the one or more partner vendor servers, wherein the consent status indicates one or more of consent, non-consent, and unavailable consent information, for the subject, and, if the consent status indicates non-consent or unavailable consent, instruct the computing device, at a web browser, to execute the instructions for the consent dialogue prompt.

### BRIEF DESCRIPTION OF THE DRAWINGS

FIG. 1 is an exemplary, network-connected environment in which the systems and methods disclosed herein may be used.

FIG. 2 is a process flow diagram illustrating execution of a method for acquiring consent from a subject to online advertisement, within the environment of FIG. 1, in accordance with an embodiment of the disclosure.

FIG. 3 is a process flow diagram illustrating interaction between the subject, an advertiser/publisher, a consent server, and one or more vendor servers, when a consent action is taken.

FIG. 4 is an illustration of an exemplary computing device, associated with the subject, upon which the consent server may serve a consent dialogue window, at a website on a browser, overlaid upon the website, in accordance with FIG. 2 and an embodiment of the disclosure.

FIG. 5 is an exemplary graphic interface of the consent dialogue window of FIG. 4, to be presented to the subject, in accordance with FIG. 4 and an embodiment of the disclosure.

FIG. 6 is another exemplary graphic interface of the consent dialogue window of FIG. 4, to be presented to the subject, in accordance with FIGS. 4-5.

FIG. 7 is another exemplary graphic interface of the consent dialogue window of FIG. 4, to be presented to the subject, in accordance with FIGS. 4-6.

FIG. 8 is an exemplary graphic interface of the browser of FIG. 4, upon completion of the consent dialogue window, to be presented to the subject, in accordance with FIGS. 4-7.

FIG. 9 is an exemplary view of a consent dialogue window overlaid on a website, as displayed wherein the computing device is a mobile device having a touchscreen, in accordance with FIG. 2 and another embodiment of the disclosure.

FIG. 10 is another exemplary view of the consent dialogue window overlaid on the website, in accordance with FIG. 9.

FIG. 11 is another exemplary view of the consent dialogue window overlaid on the website, in accordance with FIGS. 9-10.

FIG. 12 is a schematic diagram for an example computer that may execute instructions for providing the example systems and methods of the present disclosure.

While the present disclosure is susceptible to various modifications and alternative constructions, certain illustrative examples thereof will be shown and described below in detail. The disclosure is not limited to the specific examples disclosed, but instead includes all modifications, alternative constructions, and equivalents thereof.

### DETAILED DESCRIPTION

The following details systems, methods, and associated “widgets,” (e.g., dialogue prompts and/or windows, among other things) for acquiring consent to create cookies or use similar technologies, associated with a subject, upon accessing an advertiser/publisher's (“vendor”) online media (e.g., a web site, a video platform, an e-commerce platform, a mobile application, and/or any other online media space).

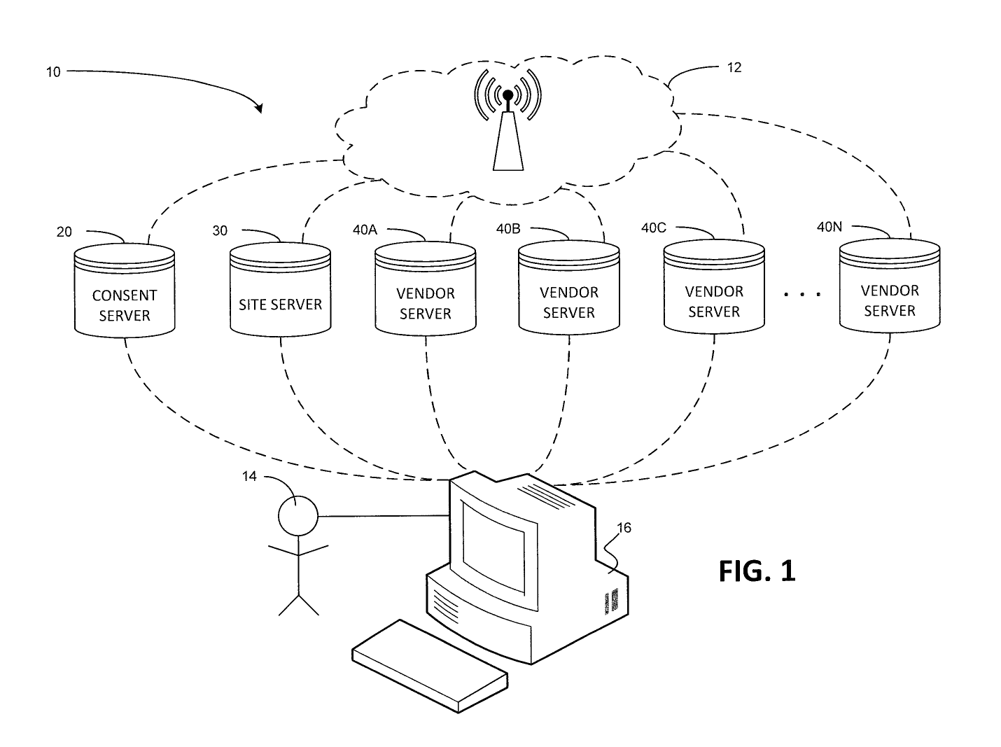

To that end, FIG. 1 illustrates an environment 10 in which actors in an online advertisement ecosystem may communicate and act in commerce over a network 12 (e.g., the Internet). In the environment 10, a subject 14 may be subject to online advertising, including targeted online advertisement based on data collected on the subject 14, and/or data collection associated with the subject 14. The subject 14 may be one individual person using a computing device 14 or, in some examples, the subject 14 may be emblematic of a plurality of persons subjected to online advertising and/or associated data collection. As indicated by the dashed lines in FIG. 1, the computing device 16, among other actors, are connected to one another via the network 12. The computing device 16 maybe any network-connectivity device capable of sending and receiving information over the network 12, including, but not limited to including, desktop computers, laptop computers, tablets, smartphones, gaming consoles, set top boxes, among other things.

Within the environment, there are a plurality of servers: a consent server 20, a site server 30, and a plurality of vendor servers 40A, 40B, 40C, . . . , 40N. Accordingly, there may be any number of vendor servers in the plurality, denoted as “vendor server 40N” for “n” number of vendor servers 40. The site server 30 provides the subject 14 with digital content (e.g., a website, a walled-garden web application, a streaming video, among other things), via the computing device 16, when the subject 14 requests said content (e.g., the subject 14, using a web browser, requests a web site and the site server 30 serves the web site content to the subject 14 via the computing device 16). Each of the plurality of vendor servers 40 are online content vendors associated with content served in association with content of the site server 30. For example, each of the plurality of vendor servers 40 attempt to provide the subject 14 with individualized content when he accesses the website of the site server 30. Examples of vendor servers 40 include online advertising servers, advertising analytics operations, general analytics operations, and any other associated web services that may collect and/or transmit data to/from the subject 14 via content of the site server 30.

The consent server 20 is provided to ascertain if the subject 14 grants any of the vendor servers 40 to target advertising to and collect data from the subject 14. Accordingly, the consent server 20, given conditions discussed in more detail below, may serve a “widget” to the subject 14, via the computing device 16, overlaid upon content provided by the site server 20. Such widgets may be used such that input from the subject 14 determines if the subject 14 consents to targeted advertisement and/or data collection by one or more of the vendors 40. Such input will be referenced herein as “affirmative indication,” or, in verb form, “affirmatively indicate.” “Affirmative indication,” as defined herein, refers to any digital action made affirmatively by the subject 14, via the computing device, that signifies an intent to select something associated with the widget. Examples of affirmative indication include, but are not limited to including, a mouse click on a designated pixel area of a display, a touch on a touchscreen in a specific pixel area of a mobile device, a specific stroke of a keyboard (physical or digitally rendered on a touchscreen), among other things.

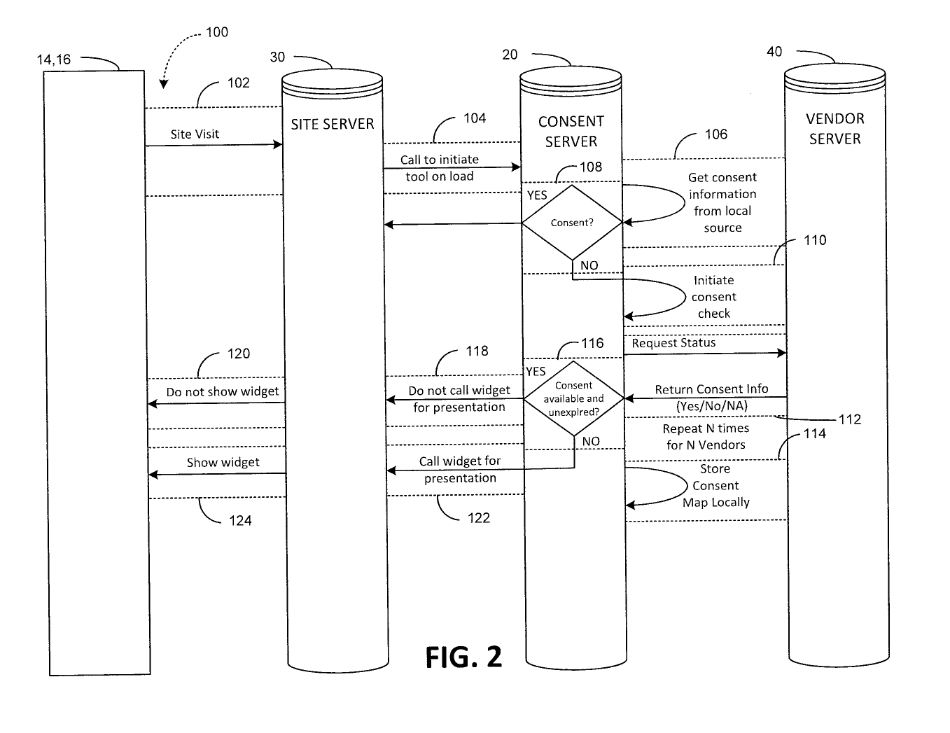

Turning now to FIG. 2, and with continued reference to FIG. 1, a method 100 for gaining consent to target advertising to and to collect data from the subject 14 is illustrated as a block diagram overlaid upon elements of the environment 10. While each of the site server 30, the consent server 20, and the vendor servers 40 are depicted as individual entities, it is certainly possible that the functions may certainly be consolidated on fewer servers and/or entities may operate via a plurality of hardware elements. At a minimum, each of the site server 30, the consent server 20, and the vendor servers 40 include a processor, a memory, and a transceiver for connecting to the network 12. Blocks of the block diagram representative of the method 100 are illustrated with dotted lines.

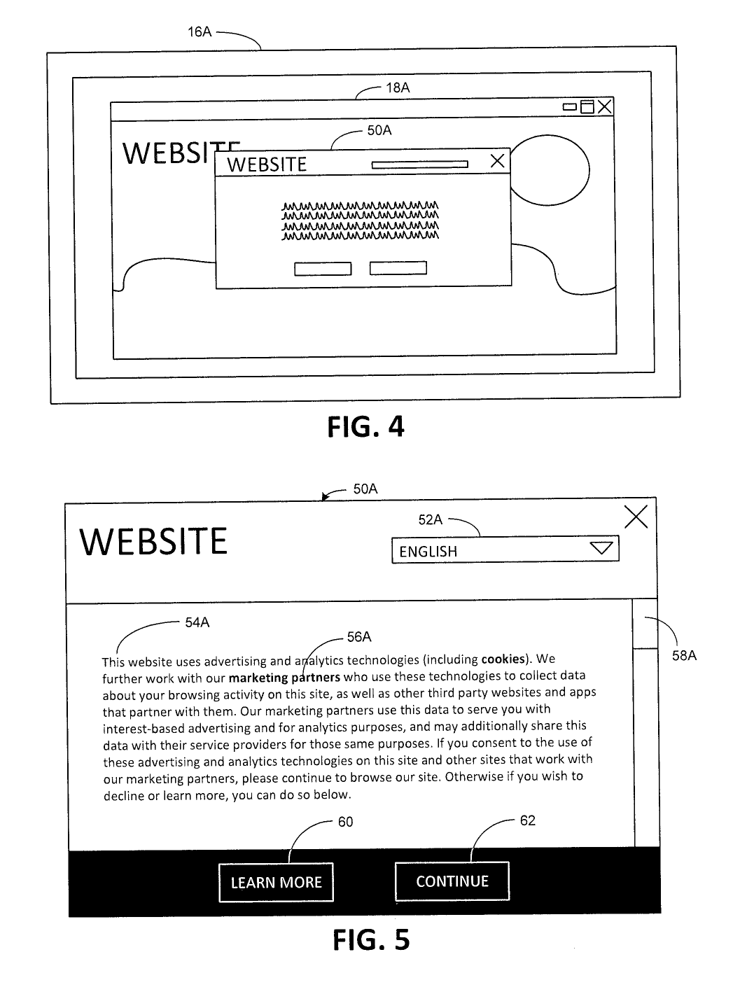

The method 100 may begin and block 102, when the subject 14, via the computing device 16, visits a website 18 hosted by the site server 30, then the site server 30 provides the computing device 16 with the data for the website 18. Referring to FIG. 4, this step is shown as the illustration of the computing device 14A shows the subject 14 accessing a website 18A at a web browser. At block 104, the site server 104, having some form of identifier passed (either local to the subject 14 or via analytical data), detects the subject and calls the consent server 20 to initiate the consent check process. At block 106, the consent server 20, in communication with the computing device 16, determines if any consent information is stored on the memory of the computing device 16 (e.g., as a cookie in the web browser) and, if such consent information exists, accesses the data. At block 108, the stored consent information data is analyzed. The consent data or information includes consent status for one or more of the vendor servers 40; the consent status can be one of three options, consent to online advertisement and data collection, non-consent to online advertisement and data collection, and unavailable consent data. If the local consent status information indicates that the subject has consented to online advertising and data collection by all vendor servers 40, then the process ends and the website 18 is displayed minus any consent dialogue window. Otherwise, if any non-consent or unavailable consent information is detected, then the method continues to block 110, wherein a consent check is indicated at the vendor servers 40. By initiating the consent check, the consent server 20 requests any consent information associated with the subject 14 from the vendor servers 40, that is, non-locally stored data indicating consent, non-consent, or unavailable consent. This is repeated for each of the vendor servers 40.

At block 114, the consent server then locally stores the consent map (e.g. as a cookie) in the browser of the computing device 16. Then, the consent information received from the vendor servers 40 is analyzed at the consent server at block 116, if there is consent available for all vendor servers 40, the method continues to blocks 118, 120, where the widget is not called for presentation and not shown. Otherwise, at blocks 122, 124, if adequate consent information is not obtained from the vendor servers 40, then the widget is called for presentation and shown as an overlay on the website 18.

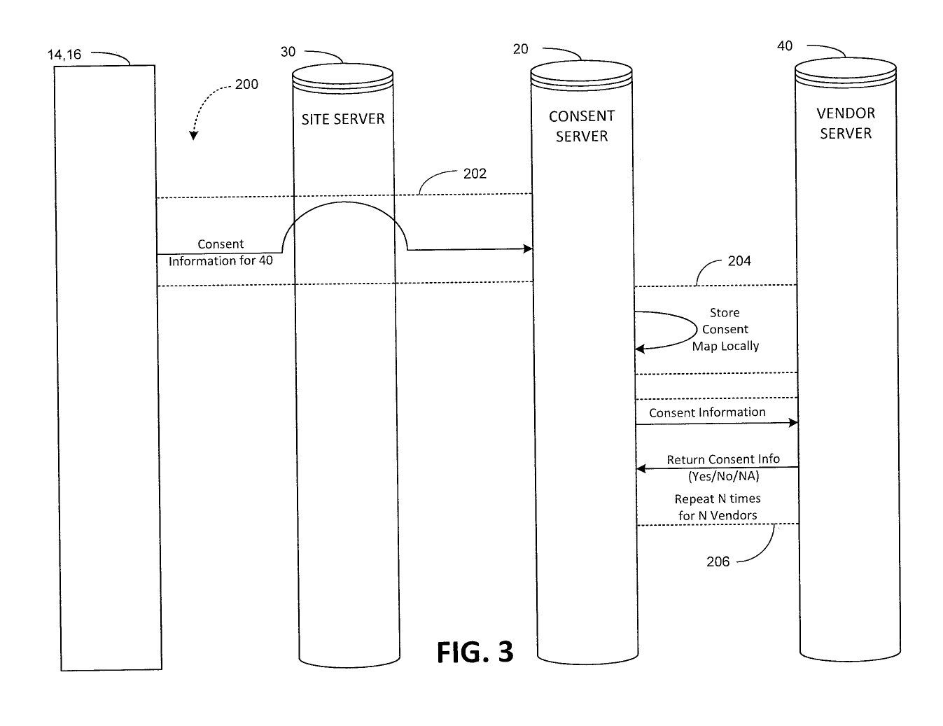

A method 200 for performing a check of consent is illustrated in FIG. 3, wherein consent information is transmitted from the subject 14 to the consent server 20 (block 202), such information is stored locally at the consent server 20 (block 204), and then the consent information is provided to the vendor server(s) 40, and any additional consent information known by the vendor server(s) 40, that is associated with the subject 14, is then sent to the consent server 20 (block 206).

FIGS. 4-7 illustrate a first embodiment of an example widget, in the form of a consent dialogue window 50A, presented to the subject 14, via the computing device 16A, after being provided by the consent server 20. As illustrated in FIG. 4, the consent dialogue window 50A is overlaid on the website 18A. In some non-limiting examples, the consent dialogue window 50A may overlay approximately 30% of the website 18A.

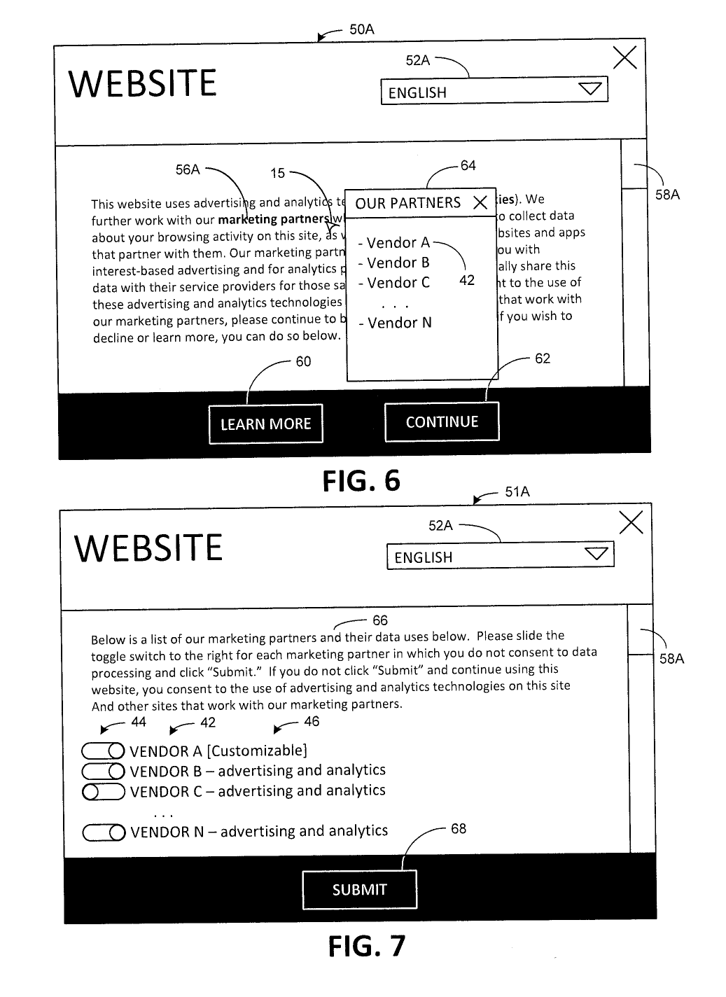

As illustrated in greater detail in FIG. 5, the consent dialogue window includes, at least, a first non-consent affirmation box 60 and a media declaration 56A. The media declaration 56A is any form of media (be it text, audio, visual, and/or video) which accurately informs the subject 24 that if any affirmative indication is made outside of one or more indicatable areas, then the subject to online advertising consents to online advertisement and data collection from a first vendor server 40A and one or more partner vendors of the first vendor server 40A. In some examples, the media declaration includes, at least, affirmative information that one or more of the plurality of vendors 40 uses cookies. While sample text is shown for the media declaration 56A in FIGS. 5-6, such text is merely exemplary in illustrating a message that accurately informs the subject 24 of the conditions of consent acquisition associated with the consent dialogue window 50A. The first non-consent affirmation box 60, which, if affirmatively indicated, indicates to the consent server 30 that the subject 24 does not consent to targeted advertising and collection of data from at least one of the first vendor server 40A and one or more partner servers 40B-N. The non-consent affirmation box 60 is defined by a specific grouping of pixels within the consent dialogue window 50A (bounds of which, in FIG. 5, are indicated by the white box called out by “60”).

As shown in FIGS. 5-7, there are a plurality of additional indicatable areas, such as a language drop-down window 52A, a scroll bar 58A, and a vendor link 56A. All indicatable areas are defined by a specific grouping of pixels within the consent dialogue window 50A. The language drop down window 52A provides options for the subject 24 to change the language of media in the media declaration. The scroll bar 58A allows the subject to scroll to different portions of the media declaration 56A. The vendor link 56A is a link to a listing of the plurality of vendors 40. In the present example the computing device 14 includes a screen with an input device that controls the cursor 15 and, when the cursor 15 affirmatively indicates the vendor link, a vendor list 42 is illustrated in a vendor partner window 64.

In some examples, the first non-consent box 60 may not lead to returning a consent status for the subject 14 of non-consent, but rather, bring the subject 14 to a second page 51A of the consent dialog window 50A, in which the subject 24 is prompted with partner instructions 66, affirmatively explaining that the subject 24 has the ability to opt in or opt out of giving consent information to any of the plurality of vendor servers 40. As illustrated, the partner instructions may include one or more partner sliders 44, each associated with a respective vendor server 40 of the partner list 42, which, when affirmatively indicated, opt in or opt out of partner consent information for the associated vendor server 40. Further, second page 51A includes a second non-consent box 68 which, when affirmatively indicated, will opt in or opt out the subject from consent, relative to the selected members of the partner sliders 44. In some examples, the partner information 66 may include specific information 46 associated with one or more of the vendor servers 44 of the vendor list 42.

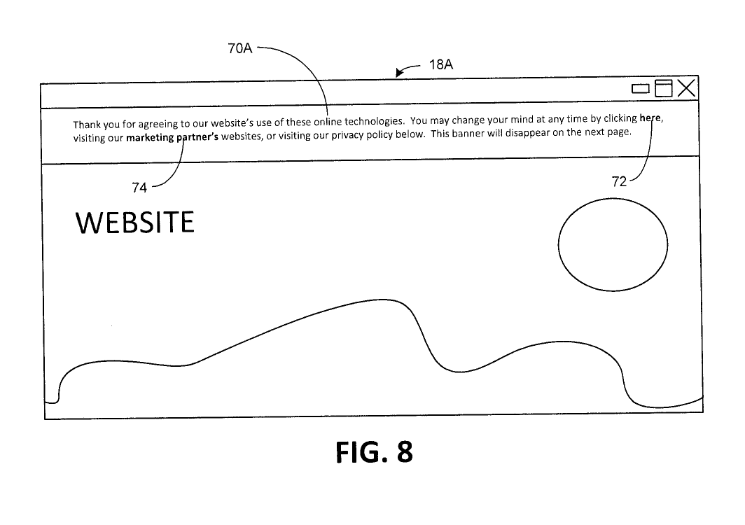

As illustrated in FIG. 8, if through interaction with the consent dialogue window, the subject 24 consents, then prompt completion message 70A, overlaid on the website 18A. In such examples the prompt completion message 70A may include a revocation link 72, which gives the user the option to revoke consent from one or more of the vendor servers 40, and/or a marketing partner link 74, which provides access to vendor websites.

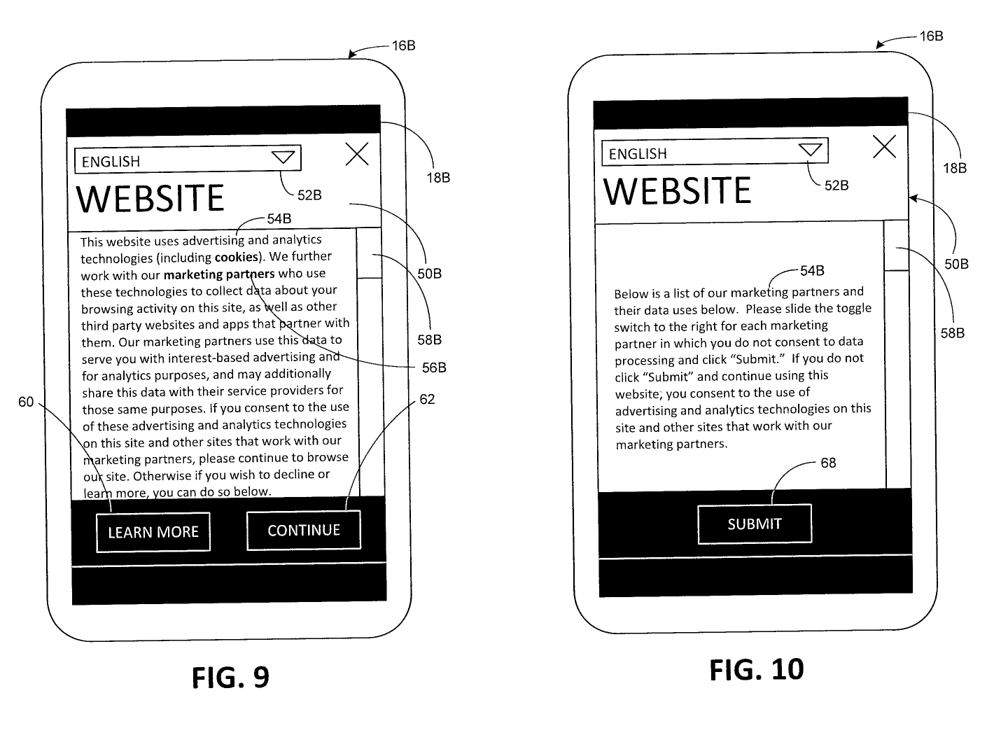

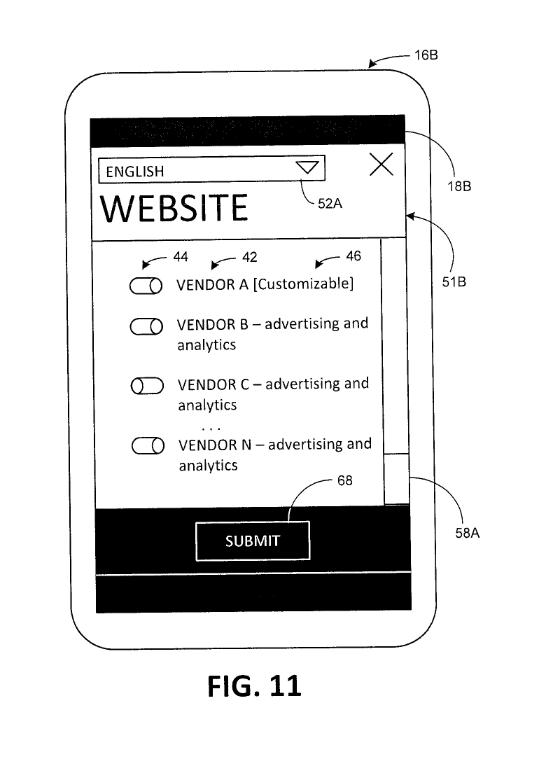

FIGS. 9-11 illustrate a second embodiment of an example widget, in the form of a consent dialogue window 50B, presented to the subject 14, via the computing device 16B, after being provided by the consent server 20. As illustrated in FIG. 9, the consent dialogue window 50B is overlaid on the website 18B.

The consent dialogue window 50B includes, at least, a first non-consent affirmation box 60 and a media declaration 56A. The media declaration 56A is any form of media (be it text, audio, visual, and/or video) which accurately informs the subject 24 that if any affirmative indication is made outside of one or more indicatable areas, then the subject to online advertising consents to online advertisement and data collection from a first vendor server 40A and one or more partner vendors of the first vendor server 40A. In some examples, the media declaration includes, at least, affirmative information that one or more of the plurality of vendors 40 uses cookies. While sample text is shown for the media declaration 56B in FIGS. 5-6, such text is merely exemplary in illustrating a message that accurately informs the subject 24 of the conditions of consent acquisition associated with the consent dialogue window 50B. The first non-consent affirmation box 60, which, if affirmatively indicated, indicates to the consent server 30 that the subject 24 does not consent to targeted advertising and collection of data from at least one of the first vendor server 40A and one or more partner servers 40B-N. The non-consent affirmation box 60 is defined by a specific grouping of pixels within the consent dialogue window 50B (bounds of which, in FIG. 9, are indicated by the white box called out by “60”).

As shown in FIGS. 9-11, there are a plurality of additional indicatable areas, such as a language drop-down window 52B, a scroll bar 58B, and a vendor link 56B. All indicatable areas are defined by a specific grouping of pixels within the consent dialogue window 50B. The language drop down window 52B provides options for the subject 24 to change the language of media in the media declaration. The scroll bar 58B allows the subject to scroll to different portions of the media declaration 56B. The vendor link 56B is a link to a listing of the plurality of vendors 40. In the present example the computing device 16B is a touchscreen enabled device and, when the subject 14 touches the touchscreen at the pixel area of the vendor link 56B, a vendor list 42 is illustrated in a vendor partner window 64.

In some examples, the first non-consent box 60 may not lead to returning a consent status for the subject 14 of non-consent, but rather, bring the subject 14 to a second page 51B of the consent dialog window 50B, in which the subject 24 is prompted with partner instructions 66, affirmatively explaining that the subject 24 has the ability to opt in or opt out of giving consent information to any of the plurality of vendor servers 40. As illustrated, the partner instructions may include one or more partner sliders 44, each associated with a respective vendor server 40 of the partner list 42, which, when affirmatively indicated, opt in or opt out of partner consent information for the associated vendor server 40. Further, second page 51B includes a second non-consent box 68 which, when affirmatively indicated, will opt in or opt out the subject from consent, relative to the selected members of the partner sliders 44. In some examples, the partner information 66 may include specific information 46 associated with one or more of the vendor servers 44 of the vendor list 42.

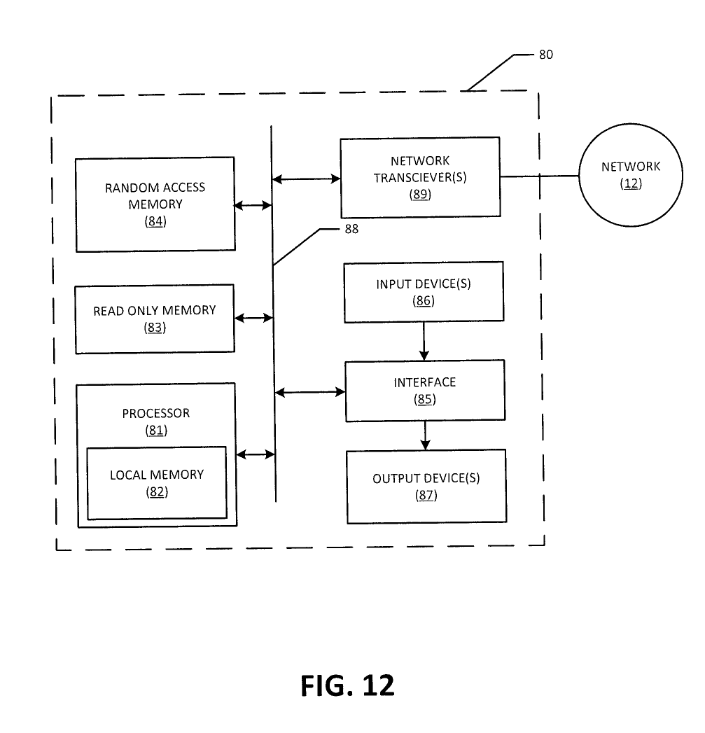

A combination of hardware and software may be used to implement instructions in association with any of the computing device 14, the site server 20, the consent server 30, and/or the vendor server(s) 40. FIG. 12 is a block diagram of an example computer 80 capable of executing instructions to realize the functions of any the computing device 14, the site server 20, the consent server 30, and/or the vendor server(s) 40. The computer 80 may be, for example, a server, a personal computer, or any other type of computing device. The computer 80 of the instant example includes a processor 81. For example, the processor 81 may be implemented by one or more microprocessors or controllers from any desired family or manufacturer.

The processor 81 includes a local memory 82 and is in communication with a main memory including a read only memory 83 and a random access memory 84 via a bus 88. The random access memory 84 may be implemented by Synchronous Dynamic Random Access Memory (SDRAM), Dynamic Random Access Memory (DRAM), RAMBUS Dynamic Random Access Memory (RDRAM) and/or any other type of random access memory device. The read only memory 83 may be implemented by a hard drive, flash memory and/or any other desired type of memory device.

The computer 80 may also include an interface circuit 85. The interface circuit 85 may be implemented by any type of interface standard, such as, for example, an Ethernet interface, a universal serial bus (USB), and/or a PCI express interface. One or more input devices 86 are connected to the interface circuit 85. The input device(s) 86 permit a user to enter data and commands into the processor 81. The input device(s) 86 can be implemented by, for example, a keyboard, a mouse, a touchscreen, a track-pad, a trackball, and/or a voice recognition system. For example, the input device(s) 86 may include any wired or wireless device for connecting the computer 80 to the positioning system 88 to receive positioning signals.

One or more output devices 87 are also connected to the interface circuit 85. The output devices 87 can be implemented by, for example, display devices for associated data (e.g., a liquid crystal display, a cathode ray tube display (CRT), etc.).

Further, the computer 80 may include one or more network transceivers 89 for connecting to the network 12, such as the Internet, a WLAN, a LAN, a personal network, or any other network for connecting the computer 80 to one or more other computers or network capable devices.

As mentioned above the computer 80 may be used to execute machine readable instructions. For example, the computer 80 may execute machine readable instructions to perform the methods shown in the block diagrams of FIGS. 2 and 3. In such examples, the machine readable instructions comprise a program for execution by a processor such as the processor 81 shown in the example computer 80. The program may be embodied in software stored on a tangible computer readable medium such as a CD-ROM, a floppy disk, a hard drive, a digital versatile disk (DVD), a Blu-ray disk, or a memory associated with the processor 47, but the entire program and/or parts thereof could alternatively be executed by a device other than the processor 47 and/or embodied in firmware or dedicated hardware. Further, although the example programs are described with reference to systems and methods above, many other methods of implementing embodiments of the present disclosure may alternatively be used. For example, the order of execution of the blocks may be changed, and/or some of the blocks described may be changed, eliminated, or combined.

1. A method for gaining consent to target advertising to and to collect data from a subject to online advertising, the method comprising:
providing, to the subject to online advertising at a computing device associated with the subject to online advertising, instructions for a consent dialogue window, the consent dialogue window served to the subject to online advertising, at the computing device, from a consent server, the consent server including, at least, a first processor, a first memory, and a first transceiver,
the consent dialogue window presented to the subject to online advertising as an overlay to a website served to the subject to online advertising, the website served to the subject to online advertising via a vendor server, the vendor server including, at least, a second processor, a second memory, and a second transceiver,
wherein the consent dialogue window includes, at least,
a non-consent affirmation box, which, if affirmatively indicated, indicates to the consent server that the subject to online advertising does not consent to targeted advertising and collection of data from at least one of the vendor servers and one or more partner vendor servers, the non-consent affirmation box defined by a specific pixel grouping within the consent dialogue window, and
a media declaration which accurately informs the subject to online advertising that if any affirmative indication is made outside of one or more indicatable areas, which include, at least, a non-consent affirmation box, then the subject to online advertising consents to online advertisement and data collection from the vendor server and the one or more partner vendor servers;
requesting a consent status of the subject to online advertisement from at least one of the vendor servers and the one or more partner vendor servers, by the consent server;
receiving the consent status of the subject to online advertisement from the at least one of the vendor servers and the one or more partner vendor servers, by the consent server, wherein the consent status indicates one or more of consent, non-consent, and unavailable consent information, for the subject to online advertisement; and
if the consent status indicates non-consent or unavailable consent, instruct the computing device, at a web browser, to execute the instructions for the consent dialogue prompt.

2. The method of claim 1, further comprising storing the consent information locally on the memory of the computing device, when received from the at least one of the vendor servers and the one or more partner servers.

3. The method of claim 1, further comprising accessing stored consent information from the memory of the computing device, by the consent server, and, if the consent information indicates consent, instructions to the computing device for displaying the website without the consent dialogue prompt.

4. The method of claim 1, wherein the one or more indicatable areas further includes a language drop down window, provided to give the subject ability to change the language of media in the media declaration.

5. The method of claim 1, wherein the one or more indicatable areas includes a link to a listing of a vendor and one or more partner vendors, the vendor associated with the vendor server and each of the one or more partner vendors associated with one of the one or more partner vendor servers.

6. The method of claim 1, wherein the media declaration includes, at least, affirmative information that one or more of the vendors and the one or more partner vendors use cookies.

7. The method of claim 1, wherein the one or more indicatable areas includes a learn more area, wherein, when affirmatively indicated, prompts the user with partner instructions affirmatively explaining that the subject has the ability to opt in or opt out of partner consent information.

8. The method of claim 7, wherein the partner instructions includes one or more partner sliders, each of the one or more partner sliders, when affirmatively indicated, opt in or opt out of partner consent information for one of the one or more partner vendors.

9. The method of claim 1, wherein the computing device includes or is otherwise associated with an input device, from which the subject to online advertising can move a cursor on a display of or associated with the computing device and provide a click of the cursor via an input of the input device, and
wherein affirmative indication is achieved via a click of the cursor when the cursor is located in a specific pixel area.

10. The method of claim 1, wherein the computing device includes a touchscreen and affirmative indication is achieved via a touch within a specific pixel area of the touchscreen.

11. A system for gaining consent to target advertising to and collect data from a subject to online advertising, the system comprising:
at least one wireless transceiver, configured to connect, in electronic communication the system to a computing device associated with the subject and a vendor server;
a non-transitory, machine readable medium having thereon consent instructions; and
a processor configured to execute the consent instructions,
wherein, when executed, the consent instructions cause the processor to:
provide, to the subject via the computing device, instructions for a consent dialogue window, the consent dialogue window served to the subject to online advertising,
wherein the consent dialogue window is presented to the subject as an overlay on a website served to the subject to online advertising,
the website served to the subject via the vendor server,
wherein the consent dialogue window includes, at least,
a non-consent affirmation box, which if affirmatively indicated, indicates to the consent server that the subject does not consent to targeted advertising and collection of data from at least one of the vendor server and one or more partner vendor servers, the non-consent affirmation box defined by a specific pixel grouping within the consent dialogue window, and
a media declaration which accurately informs the subject that if any affirmative indication is made outside of one or more indicatable areas, which include, at least, a non-consent affirmation box, then the subject to online advertising consents to online advertisement and data collection from the vendor server and the one or more partner vendor servers;
request a consent status of the subject from at least one of the vendor server and the one or more partner vendor servers,
receive the consent status of the subject the at least one of the vendor server and the one or more partner vendor servers, wherein the consent status indicates one or more of consent, non-consent, and unavailable consent information, for the subject,
if the consent status indicates non-consent or unavailable consent, instruct the computing device, at a web browser, to execute the instructions for the consent dialogue prompt.

12. The system of claim 11, wherein the consent instructions further include instructions which, when executed, cause the processor to store the consent information locally on the memory of the computing device, when received from the at least one of the vendor server and the one or more partner servers.

13. The system of claim 11, wherein the consent instructions further include instructions which, when executed, cause the processor to access stored consent information from the memory of the computing device and, if the consent information indicates consent, instructions to the computing device for displaying the website without the consent dialogue prompt.

14. The system of claim 11, wherein the one or more indicatable areas further includes a language drop down window, provided to give the subject ability to change the language of media in the media declaration.

15. The system of claim 11, wherein the one or more indicatable areas includes a link to a listing of a vendor and one or more partner vendors, the vendor associated with the vendor server and each of the one or more partner vendors associated with one of the one or more partner vendor servers.

16. The system of claim 11, wherein the consent dialogue prompt, when overlaid on the website, comprises approximately thirty percent of a window of the browser.

17. The system of claim 11, wherein the media declaration includes, at least, affirmative information that one or more of the vendor and the one or more partner vendors use cookies.

18. The system of claim 11, wherein the consent dialogue prompt, when overlaid on the website, comprises approximately thirty percent of a window of the browser.

19. The system of claim 11, wherein the computing device includes or is otherwise associated with an input device, from which the subject to online advertising can move a cursor on a display of or associated with the computing device and provide a click of the cursor via an input of the input device, and
wherein affirmative indication is achieved via a click of the cursor when the cursor is located in a specific pixel area.

20. The system of claim 11, wherein the computing device includes a touchscreen and affirmative indication is achieved via a touch within a specific pixel area of the touchscreen.
